(19) United States
(12) Patent Application Publication
(10) Pub. No.: US 2007/0198928 A1
(43) Pub. Date: Aug. 23, 2007

(54) DESIGN METHOD AND APPARATUS FOR USER INTERFACE

(76) Inventor: Chi-Hsiung Tseng, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/309,682

(22) Filed: Sep. 11, 2006

(30) Foreign Application Priority Data
Feb. 23, 2006 (TW) 95106040

(51) Int. Cl. G06F 3/00

(52) U.S. Cl. 715/713; 715/810

(57) ABSTRACT

A method and an apparatus for designing user interface are disclosed. The method is processed by a user interface processing program installed in an electronic device and comprises following steps. First, at least one key is provided. Then, a menu is provided, wherein the menu is a tree structure having a root node and a plurality of connected nodes, at least one sub-node family can be derived from each node, wherein for each node it is defined one of a property, at least one key to receive, a picture to display, and an action to execute, or the combination thereof. Afterwards, a display for displaying the picture of the node is provided, wherein key is suitable for moving the node to an adjacent node.

### CROSS-REFERENCE TO RELATED APPLICATION

This application claims the priority benefit of Taiwan application serial no. 95106040, filed on Feb. 23, 2006. All disclosure of the Taiwan application is incorporated herein by reference.

### BACKGROUND OF THE INVENTION

1. Field of Invention

The present invention relates to a structure of the user interface and the design method thereof. Particularly, the present invention relates to a user interface structure with an independent menu and program, and the related design method thereof.

2. Description of Related Art

Generally an electronic apparatus on the market is designed with a user interface for the user to operate various functions of the electronic apparatus. The user interface is usually defined by the product developers who organize, arrange, and define the menu structure, the meaning of the keys, and the corresponding actions of the keys for the user interface. Thus, the user can only use the defined user interface to operate various functions of the electronic apparatus.

As to a small-screen mobile electronic apparatus, such as cell phone, MP3 player, recorder, flash disc, and PDA, etc., the user interface of such electronic apparatus has to be simple for the user convenience since the screen is small, and the picture to be displayed is very limited. Such user interface usually includes 3 parts: an operation picture (or referred to as the menu) for displaying the user selectable items, a set of keys, and some system prompting messages, including audio and video.

The foregoing menu allows the user to select from the different menu items to operate the electronic apparatus to perform certain functions, wherein each menu item may have a plurality of sub menu items, and the sub menu items may further have their own sub menu items. The menu is usually represented as a tree structure of the data structure, and the menu items thereof are corresponding to the nodes in the tree structure.

Usually a picture presents a plurality of siblings together for user convenience, and the siblings are a part of a particular menu item family.

The foregoing keys are usually categorized as two kinds, (1) Direction, which allows the user to move from one menu item (node) to another menu item (node), and generally includes: up, down, left, and right. If the position of the root node of the menu is at the leftmost part of the menu, and the sub nodes thereof are at the right side, then the up-, down-, left-, and right-key denotes moving to its: elder brother node, younger brother node, parent node, and son node respectively.

Besides, the present menu item (referred to as the current menu item thereinafter) is usually displayed in a special display mode (for example, highlight), so as to emphasize the position of the current menu item. When moving between various menu items, if the arrived menu item does not have any sub menu item, pressing the key (usually right key) which represents going to the sub menu item usually represents the action of “selection”. The selection may mean a particular parameter is selected, or a particular action starts executing; and the execution of such action usually happens at the final end of the menu, or the “leaf node” in terms of the tree structure.

(2) Modification to a particular action being executed, for example, when the apparatus has started playing music, a particular key is pressed down to adjust the volume, and another key is pressed down to change the song.

Through the foregoing definitions of the menu and the keys, the user can navigate through the menu by entering the keys and execute the required function, according to the displayed icon or text of each menu item. However, the functions of the user interfaces of all the electronic apparatuses have to be executed by the programs stored therein, the functions such as displaying the menu, detecting the keys, and outputting the responding message, etc. If the menu structure, the meaning of the keys, or the output of the prompting messages need change, the user interface execution program has to be changed which is not only time-consuming but also impossible for the users to customize the user interface according to their own requirements.

In addition, the conventional method for creating menu picture is also very time-consuming. As described above, when the user moves around the various menu items through the keys, every time a new current menu item is reached, the screen must display the picture showing the current menu item together with its neighboring sibling menu items. The co-shown sibling menu items vary with the current menu item. Therefore, a display picture has to be designed for each menu item. The number of shown menu items is restricted by the size of the screen, and is also affected by the picture designer's preference. If the number of the shown menu items or their relative display positions needs change, the entire picture has to be re-designed all over again. In addition, as described above, the display mode of the current menu item is usually different from those of other menu items around it. The aforementioned highlight is only one of the display modes. For colored screens, the display mode may include: changing of brightness or color, being framed, being overlapped with other picture, etc. These variations need the designer to re-create the picture for each menu item, even when the other co-shown menu items need not change.

### SUMMARY OF THE INVENTION

Accordingly, the present invention provides a user interface structure and the design method thereof, wherein the user can determine the menu structure and the meaning of the key of the electronic apparatus according to his/her own requirement; furthermore, achieving the purpose of customizing a user interface without changing the user interface program.

According to another aspect of the present invention, a method for generating pictures quickly and efficiently is provided. According to this invention, the designer can systematically arrange the position of each menu item on the picture, select the source of the menu item, and describe the display mode of the current menu item, so that the computer can produce the picture for all the menu items easily.

To achieve the aforementioned and other objectives, the present invention provides a user interface method, which is processed by a user interface processing program installed in the electronic device. The user interface method comprising: providing at least one key, providing a menu, and providing a display. Wherein the menu is a tree structure having a root node and a plurality of connected nodes, at least one sub-node family can be derived from each node. And for each node it is defined one of a property, at least one key to receive, a picture to display, and an action to execute, or the combination thereof. The display is suitable for displaying the picture of the node. And the key is suitable for moving the node to an adjacent node.

The present invention provides a descriptive tool for a user interface, suitable for defining a user interface of an electronic device. The user interface descriptive tool comprising a menu structure defining tool, a node defining tool, a picture defining tool, and an output tool. Wherein, the menu structure defining tool is suitable for defining a menu structure, which is a tree structure having a root node and multiple connected nodes, and defining the menu structure which comprises defining at least one sub-node family derived from each node. The node defining tool is suitable for defining one of a property, an action to execute, and at least one key to receive of each node, or the combination thereof. The picture defining tool is suitable for defining a picture of each node. The output tool is suitable for outputting a menu data structure, comprising the foregoing data of each nod.

The present invention provides a user interface parsing method of an electronic device, wherein the electronic device comprises a picture display, at least one key, and an apparatus menu data structure. The parsing method is initialized with a current node and comprises reading the data of the current node from the apparatus menu data structure whose data comprises at least one offset data, at least one key to receive, a picture to display, and an action to execute. Then, the current node according to a key and the offset data is updated when the key is entered by the user and is received.

The present invention provides a method for producing the picture data of the menu item, suitable for displaying on a screen of an electronic device, wherein the picture displays at least one menu item of a menu item family. In the method, a template defining tool is provided for the user to define at least a template which comprises at least one frame, wherein the data of the frame comprises a position, a menu item code, and a display mode. Moreover, a connecting tool is provided for the user to connect one of the templates to the menu item family which the menu item belongs to. Furthermore, the picture data of the menu item is constructed according to the definition of the connected template.

This invention successfully separates the user interface and the user interface processing program, thus allows the design of the menu structure and the meaning of the keys completely independent from the program installed in the electronic device/apparatus. Therefore the users can design the menu and keys according to their requirement without changing any program.

In order to make the aforementioned and other objects, features and advantages of the present invention comprehensible, a preferred embodiment accompanied with the figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate the embodiments of the invention and, together with the description, serve to explain the principles of the invention.

FIG. 1 is a schematic block diagram of a user interface design according to an exemplary embodiment of the present invention.

FIG. 2 is a schematic diagram of a menu structure according to an exemplary embodiment of the present invention.

FIG. 3 is a flowchart of a user interface design method according to an exemplary embodiment of the present invention.

FIG. 4 is a flowchart of a user interface descriptive tool according to an exemplary embodiment of the present invention.

FIG. 5 illustrates a template according to an exemplary embodiment of the present invention.

FIG. 6 is a flowchart illustrating the parsing/processing method of the user interface of an electronic device according to an exemplary embodiment of the present invention.

FIG. 7 is a flowchart illustrating the method for producing a menu item picture according to an exemplary embodiment of the present invention.

### DESCRIPTION OF EMBODIMENTS

The exemplary embodiments of the present invention will be explained below to describe the content of the present invention clearly.

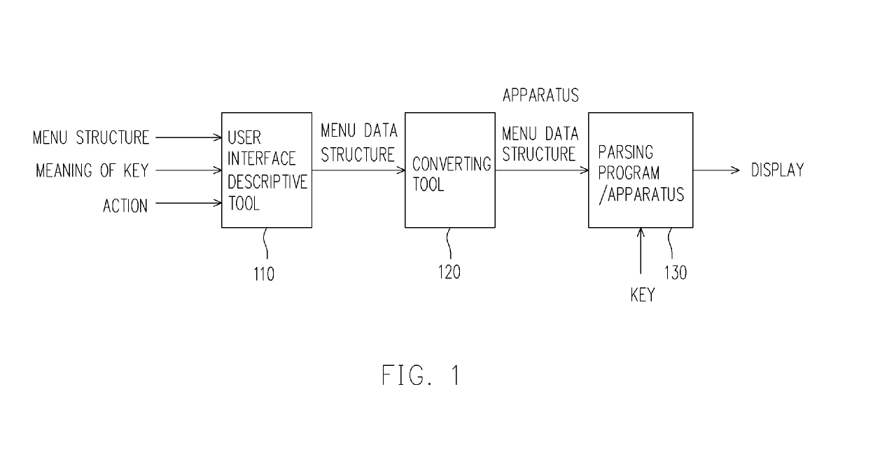

FIG. 1 is a schematic block diagram of a user interface design according to an exemplary embodiment of the present invention. Referring to FIG. 1, the structure of the present embodiment includes a user interface descriptive tool 110, a converting tool 120, and a parsing program/apparatus 130, which together create a user interface design method completely separating the menu and the program. Wherein, the user interface descriptive tool 110 and the converting tool 120 can be software tools executed in personal computers and are used by the direct user or the user interface designer (both referred to as the “user” thereinafter). The parsing program/apparatus 130 is disposed in the electronic apparatus and developed by the designer of the electronic apparatus.

The “keys” in the present invention refer to the keys which the user can define the functions thereof, and do not include those keys whose functions can not be changed by the user, such as power on/off, reset, etc. The user interface of the present invention includes: a set of keys, a single menu, and a picture display. Wherein, the pictures may include but not limited to: patterns, characters, animations, sound, light effects, vibration, and scent, etc. The menu in the present invention is a tree structure having a root node and a plurality of connected nodes, and one or a plurality of sub-node families can be derived from each node. One difference between the present tree structure and the conventional tree structure is that one node can derive more than one sub-node families for this invention.

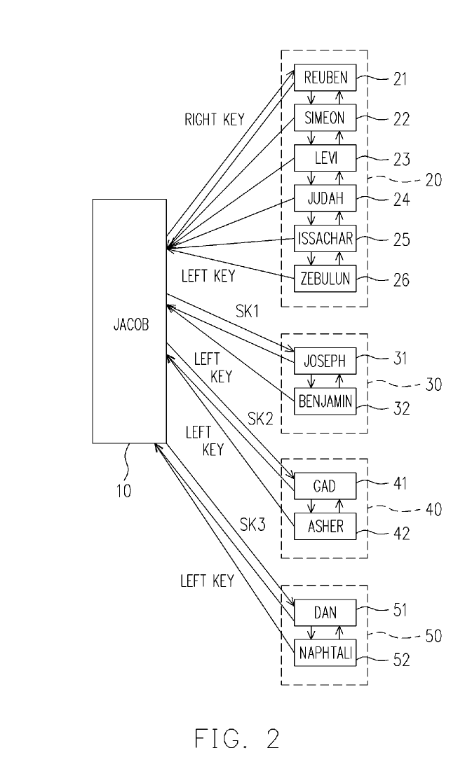

The tree structure is always explained with the family tree. The menu structure in the present invention can be explained as a polygamous family tree. FIG. 2 is a schematic diagram of a menu structure according to an exemplary embodiment of the present invention. Taking the Old Testament Jacob as an example, Jacob and Leah had six children: Reuben, Simeon, Levi, Judah, Issachar, and Zebulun. If we take Jacob as a parent node 10, then Reuben 21, Simeon 22, Levi 23, Judah 24, Issachar 25, and Zebulun 26 are “sibling nodes” to each other, and they form a first node family 20, which is also referred to as the “direct lineage sub-node family” of Jacob 10. For example, starting from the parent node of Jacob 10, the eldest son Reuben 21 of the sub-node family 20 can be reached through a normal right key, and then the other sub-nodes can be reached with the normal up and down keys between the siblings of the first node family 20. By the normal left key, users can move from any sub-node of the first node family 20 to the parent node, Jacob 10.

Jacob further begat Joseph 31 and Benjamin 32 with Rachel. Similarly, the two children form a second node family 30, which is a “concubine sub-node family” of Jacob. For example, starting from Jacob 10, the eldest son Joseph 31 of the second node family 30 can be reached through the super key 1 (SK1) of the present invention, and then it is possible to move between the sibling nodes, i.e. Joseph 31 and Benjamin 32, of the second node family 30 with a normal up/down key. Similarly, it is possible to return to the parent node Jacob 10 from any sub-node of the second node family 30 through the normal left key.

Besides, Jacob begat Gad 41 and Asher 42 with Zilpah. Similarly, the two children form a third node family 40, which is also a concubine sub-node family of Jacob. For example, starting from Jacob 10, the eldest son Gad 41 of the third node family 40 can be reached through the super key 2 (SK2) of the present invention, and then it is possible to move between the sibling nodes, i.e. Gad 41 and Asher 42, of the third node family 40 through the normal up/down key. Similarly, it is possible to return to the parent node Jacob 10 from any sub-node of the third node family 40 through the normal left key.

Jacob further begat Dan 51 and Naphtali 52 with Bilhah. Similarly, the two children form a fourth node family 50, which is also a concubine sub-node family of Jacob. For example, starting from Jacob 10, the eldest son Dan 51 of the fourth node family 50 can be reached with a super key 3 (SK3) of the present invention, and then it is possible to move between the sibling nodes, i.e. Dan 51 and Naphtali 52, of the fourth node family 50 through the normal up/down key. Similarly, it is possible to return to Jacob 10 from any sub-node of the fourth node family 50 through the normal left key.

Although in the above embodiment, the Right key or Super Keys can lead to the eldest son of either the direct lineage or the concubine sub-node families, both the destination nodes to reach and the keys to use are merely illustrative examples and are not for limiting the invention. Actually, the destination and the definition of the key can be freely set by the user when defining the node.

In the present invention, user can define each node with: the keys it can receive, the display picture, the action to be executed, and other properties. In this invention, the function of the key is only for moving from a node to its adjacent node, that is, changing the current node, rather than executing an action. The node's adjacent nodes may include: its parent node, its sibling nodes that are direct next to it, its direct lineage eldest son node and the concubine eldest son nodes of the concubine sub-node families thereof. By defining the keys that a node can receive and the key's moving direction, the user can define the ways to navigate from the current node to its adjacent nodes. The directions in this invention are the “general directions” of moving between the adjacent nodes, and may include the conventional four directions in the 2-D space which are up, down, left, and right, or up left, down left, up right, and down right And the Right, UpRight, or DownRight key may direct to the direct lineage eldest son node of the node; the Left, UpLeft or DownLeft key may direct to the parent node of the node; the Up, UpLeft, or UpRight key may direct to its elder brother node which is next to it; and the Down, DownLeft, or DownRight key may direct to its younger brother node which is direct next to it. Besides, a plurality of super keys (SK) can be further defined to direct to one of the concubine sub-nodes in its concubine sub-node family, such as the concubine eldest son sub-node. These concubine sub-nodes usually include but not limited to changing the selectable parameters or the execution mode for a particular action.

In addition, the properties of the nodes can be configured, for example: visible, invisible, instant execution, execution on exit, execution on right key, etc. The visible nodes are the menu items, thus, the visible node family is the menu item family.

The user interface descriptive tool 110 of the present invention allows the user to define menu structure, which includes defining the picture, the keys to be received, the properties, and the action to be executed for each node, so as to create a menu data structure. Therefore, the menu data structure contains the data for each node, including: a picture representing the node, the properties, the keys to receive, the relation/offset between the adjacent nodes, and the action to be executed when the node is selected, etc. The converting program 120 is used for converting the menu data structure into an apparatus menu data structure which is exclusively used in the electronic apparatus.

Moreover, the parsing program/apparatus 130 receives the keys entered by the user, and determines which node to enter according to the key definition corresponding to the entered key, and which action to execute according to the current node data. Wherein, which node to enter can be calculated from the current node, the moving direction defined by the input key, and the offset between the nodes recorded in the apparatus menu data. The action can be executed by the electronic apparatus through directly invoking the execution program stored in the apparatus menu data structure.

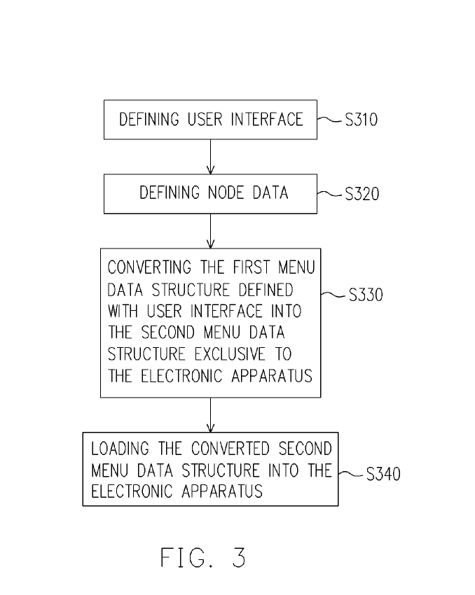

Since the special design of separating the menu structure from the program is adopted in the present invention, the users can define the menu structure and the meaning of the keys according to their own requirement without changing the program, so as to create a customized user interface. FIG. 3 is a flowchart of a user interface design method according to an exemplary embodiment of the present invention. Referring to FIG. 3, in the present embodiment, the user interfaces of the electronic apparatuses, such as mobile phone, PDA, digital camera, and MP3 player, etc., can be designed accordingly.

First, the user interface is defined with a user interface descriptive tool (step S310). The user interface includes a menu which is a tree structure having a root node and a plurality of connected nodes, wherein at least one sub-node family can be derived from each node. Next, the data of each node of the tree structure is defined (step S320), which include: (1) the properties such as visible, invisible, instant execution, execution on exit, execution on right key, etc., wherein visible node is regarded as the menu item in the menu; (2) the meaning or the code of the acceptable key for the node.

The function of the key is moving the node to the adjacent node as aforementioned above, wherein the adjacent node may include one of: the parent node, the elder brother node which is next to the node, the younger brother node which is next to the node, the direct lineage eldest son node, and the concubine sub-node (generally the concubine eldest son node), of the node, or the combination thereof. Among the sub-node families derived from each node, only one is the direct lineage sub-node family, and the others are all the concubine sub-node families. Besides, the keys may further include the super key for moving the node to one of the concubine sub-nodes, which could be the concubine eldest son node in practice.

(3) Node picture. When the property of the node includes invisible, the data of the node picture can be set to NULL, and when the property of the node is visible, the data of the node picture can be generated through the following steps. Connect one or a plurality of icons (or meta) to each visible node (i.e. menu item) in the menu. Since the menu item usually co-shows with its neighboring sibling menu items in the picture for the convenience of the user selection, the present invention allows the user to define a template for the menu item family, regarding the disposition design for the co-shown menu item family members on the same picture, wherein the size of the template is about the size of the screen of the electronic apparatus. Different dispositions can be described with different templates, so that each menu item family can select its presentation style by linking to the appropriate template. Then the picture of visible nodes (i.e. menu items) can be created according to the template linked by its family. (4) the action to be executed by the node. Similarly, when the node does not have to execute any action, the data of the action can be set NULL.

However, in some circumstances, the node data can also be defined (step S320) before defining the menu structure (as step S310), or both steps can be performed interchangeably. When the data for all the nodes on the menu structure have been set up, a first menu data structure can be output, which contains each node data including one of: the picture, the keys to receive, the offsets, the action, the properties, or the combination thereof. Wherein, the offsets refer to the memory offsets between the node and the adjacent nodes led by the keys thereof.

Besides the properties of the node, the picture of the node may also include: image, text, picture, sound, light effect, and animation, etc. The actions executed by the node include: power on/off the electronic apparatus, play/pause/stop the music, etc., which may be changed along with the development of the technology, and the foregoing examples are not for limiting the present invention. Moreover, the methods or steps disclosed above may also be implemented as the means, tools, or devices for the user to accomplish these methods or steps.

Next, the first menu data structure containing the definition of the user interface is converted into a second menu data structure (apparatus menu data structure) exclusively used by the electronic apparatus with the converting tool (step S330), which includes checking the actions of the first menu data structure with all the map files of the electronic apparatus to find out the address of the apparatus program corresponding to each action, and storing the action program addresses into the apparatus menu data structure (i.e. the second menu data structure).

Next, the converted second menu data structure is loaded into the electronic apparatus (step S340). When the electronic apparatus is turned on, the parsing program/apparatus in the electronic apparatus will direct the node to move to the adjacent node and execute the action of the node according to the key entered by the user and the node data of the second menu structure.

In another embodiment, a user interface method is further provided, which is processed by the user interface processing program installed in the electronic apparatus. The user interface method includes: providing at least a key, a menu, and a display. Wherein, the menu is a tree structure including a root node and a plurality of connected nodes, and at least one sub-node family can be derived from each node, For each node, it is defined with one of : the property, the key to receive, the picture to display, and the action to be executed, or the combination thereof. In addition, the function of the foregoing key is to move the node to an adjacent node, and the display is for displaying the picture of the node.

Through the foregoing user interface method, the design of the user interface is independent from the processing program of the user interface. When the design of the user interface is changed, the updated user interface can be presented without changing the user interface processing program, so that the time for the user interface designer to modify the program can be saved considerably. Moreover, the method or steps disclosed above also include the means, tools, or devices for the user to accomplish these method or steps.

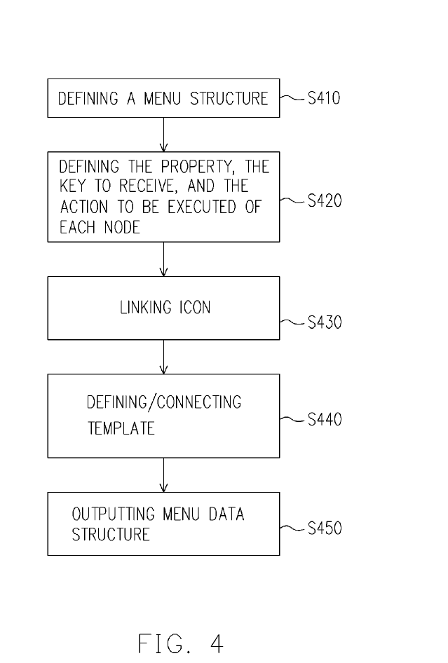

FIG. 4 is a flowchart of a user interface descriptive tool according to an exemplary embodiment of the present invention. The present embodiment is to explain how to create a menu data structure by using the user interface descriptive tool.

First, a menu structure is defined with a menu structure defining tool (step S410). The menu structure is a tree structure having a root node and a plurality of connected nodes, and the step of defining the menu structure includes defining at least one derived sub-node family for each node.

Next, the properties, at least one key to receive, and the action to be executed of each node are set by using the node defining tool (step S420). Wherein, the data listed above is only used as an embodiment of the present invention, but not for limiting the scope of the present invention. The user can set one of the data described above or the combination thereof according to the actual requirement. In some circumstances, the node data can also be defined (step S420) before defining the menu structure (as step S410), or both steps can be performed interchangeably.

After that, the picture of each node is defined by using the picture tool. When the property of the node includes invisible, the picture data of the node can be set NULL, and when the property of the node includes visible, the picture data of the node can be used to link each visible node to at least one icon in step S430, and the user can select one or a plurality of icons as the display icons of the menu item, wherein the icons include one of: picture, text, image, animation, or the combination thereof, and the format of the icon is selected from the formats supported by the electronic apparatus, for example, bitmap (BMP) format, etc.

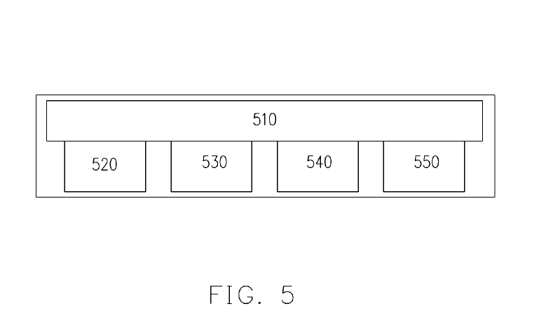

In addition, a plurality of templates can be defined with the template tool (step S440), and link for each visible node family one of the defined templates, so as to create the picture of each visible node (i.e. menu item). FIG. 5 is an embodiment of a template, which can accommodate four menu items arranged side by side, so as to divide the screen into five rectangle frames 510, 520, 530, 540, and 550. Frames 520˜550 represent the actual positions of the four menu items, and frame 510 represents another icon of the selected menu item (i.e. the current menu item), which can be a text icon representing the title of the menu item in the present embodiment. The function of the template is not only for denoting the position of the menu items on the screen, but also for allowing the user to define the source of the menu items in the menu item family and the display mode for each frame. Wherein, there are two indication methods for the source of menu items. One is relative indication method and the other is absolute indication method. In the relative indication method, a current menu item is used as the base, the previous menu item is regarded as the current menu item minus 1, and the menu item before the previous menu item is regarded as the current menu item minus 2, and so on; the next menu item is regarded as the current menu item plus 1, and the menu item after the next menu item is regarded as the current menu item plus 2, and so on. By deeming that the family members are arranged in a circle (i.e. “Mod” operation), the result of addition and deduction cannot exceed the maximum number of the menu item, or become negative. In the absolute indication method, a menu item is represented by a serial number thereof in the node family, for example, if there are 6 sub menu items in a menu item family, then the code of the first menu item is 1 and the code of the last menu item is 6.

It should be noted that with the limitation of the screen size of the electronic apparatus, it is not necessary to display all the menu items of a menu item family on the screen at the same time, thus, the frame number of the template does not have to be equal to the menu item number of the menu item family, and different menu item families may use different templates according to the family display style. Besides, the template allows the user to choose the display mode of each frame, in an exemplary embodiment, the display mode could be highlight, brightening, overlapping with an existing picture, etc. Those skilled in the art can use other display modes to increase the variation of the picture without departing from the scope of the present invention. Moreover, the method or steps disclosed above also include the means, tools, or devices for the user to accomplish these method or steps.

The present invention provides a “template” to define the presentation style of a menu item family thus facilitates the picture creating efficiency and the flexibility for the user to arrange the relative positions of various menu items, the source of the menu items, and the display modes thereof on the picture. The template allows the computer to easily create menu item picture accordingly. When the arrangement of the picture needs to be changed, no matter: the disposition position, the menu item source, or the display mode, the user only needs to change the template, and all the co-shown sibling menu items will change accordingly. Furthermore, even though a picture is needed for each menu item, only a few templates are required for creating the pictures.

After defining and linking the template, the data of each defined node can be output as a menu data structure by using the output tool. The menu data structure contains the data for each node of the menu and includes: the property, the definition of the keys to be received, the offset of each key leading to the adjacent node, the display picture, and the action to be executed, etc. (step S450).

The characteristics of the present menu data structure is that no matter how the user interface is changed, as long as it is stored according to the present menu data structure, it can be read by any user interface parsing program/apparatus disclosed in the present invention, and behave exactly the way as required by the new user interface.

It should be noted that the operation flow of the foregoing user interface descriptive tool is only an embodiment of the present invention, but not for limiting the order of the steps. The user can adjust the order flexibly according to the actual requirement. Moreover, the method or steps disclosed above also include the means, tools, or devices for the user to accomplish these method or steps.

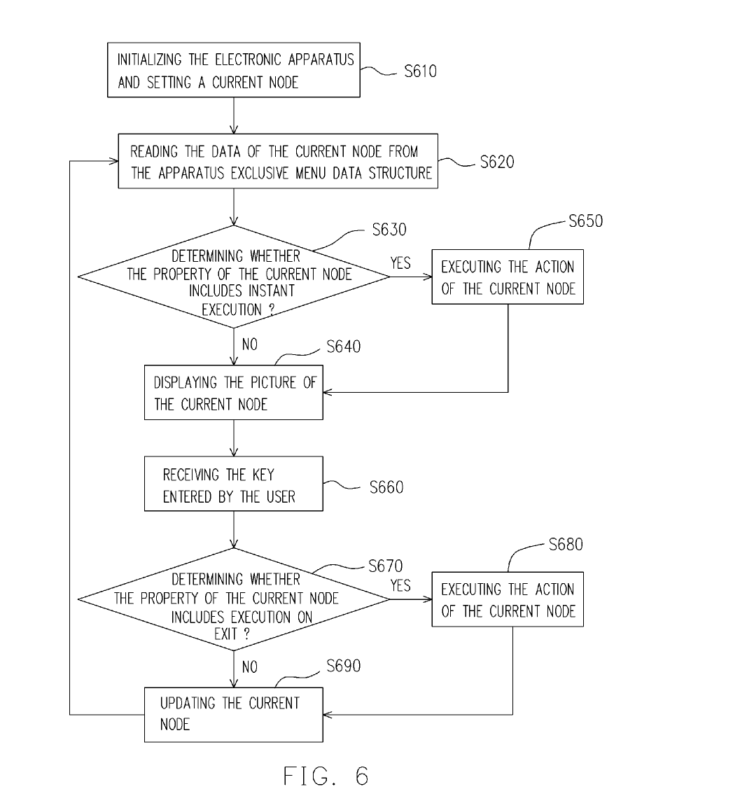

FIG. 6 is a flowchart illustrating the parsing of the user interface of an electronic device according to the apparatus menu data structure in an exemplary embodiment of the present invention. The parsing method/apparatus is a method/apparatus executed in a user apparatus (such as, cell phone, MP3 player, and PDA, etc), and the function thereof is to read the apparatus menu data structure and to respond to the key entered by the user, which includes moving the node and executing the predetermined actions of the nodes.

First, the electronic apparatus is initialized so that a current node is set when the electronic apparatus is turned on. The position of the current node derived from the apparatus menu data structure (second menu data structure) is used as the current position (step S610). Initially the current node is usually located in the first layer of the menu structure. Next, the data of the current node is read from the apparatus menu data (step S620), which includes the offset data of the node towards various directions, at least a key to receive, the picture to display, the action to execute, and the property, etc.

Next, a first determining tool is used for determining whether the property of the current node includes instant execution according to the node data (step S630). If NO, the electronic apparatus displays the obtained picture data on the screen (step S640). Now the user can see it, and the electronic apparatus waits for the next input from the user; on the other hand, if YES (instant execution), the electronic apparatus executes the action of the current node first (step S650), then displays the picture of the current node after executing the action (step S640).

If the user enters a key, the parsing method/apparatus receives the key entered by the user with a receiving apparatus (step S660), and determines whether the property of the current node includes execution on exit by a second determining tool (step S670). If YES, the electronic apparatus executes the action of the current node first (step S680), then calculates the position of the new node according to the position of the current node and the offset data of the received key, and uses the new node as the current node (step S690). On the contrary, if NO (not executed on exit), the parsing method/apparatus takes the new node as the current node directly (step S690), then returns to step S620 to re-read the data of the new current node.

Moreover, in another embodiment of the foregoing parsing method/apparatus, the second determining tool can be replaced by a third determining tool. The third determining tool determines whether the property of the current node includes execution on right key. If the key entered by the user is the right key, the action of the current node is executed first (S680) and then the current node is updated (S690); otherwise the parsing method/apparatus directly updates the current node (S690). However, the application of the determining tools is only an embodiment of the present invention, but not for limiting the present invention. The user can use other determining tools for determining the action execution of the current menu item according to the actual requirement.

To sum up, the present parsing method/apparatus only relates to the menu data structure, thus, can adopt any user interfaces without changing itself.

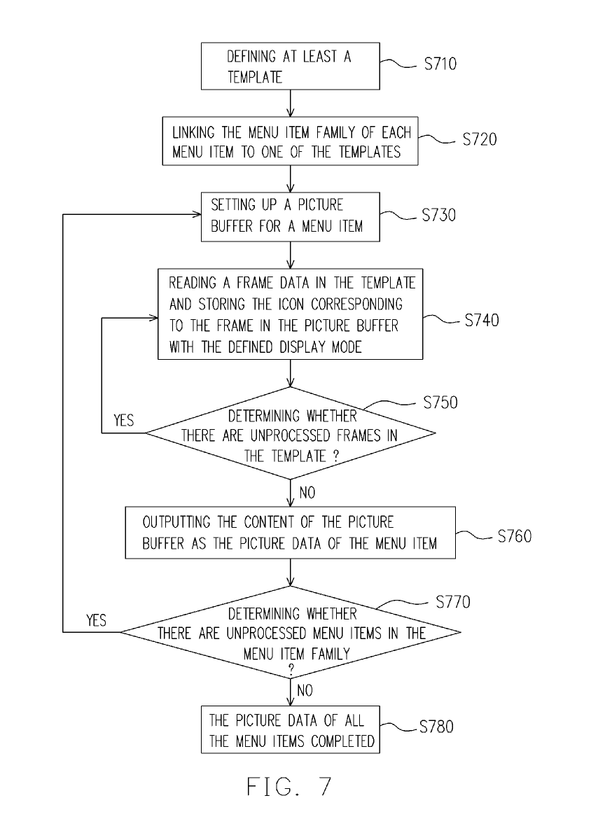

FIG. 7 is a flowchart illustrating the method for producing a menu item picture according to an exemplary embodiment of the present invention. In the present embodiment, templates are used for creating the picture data of the menu item for displaying on the screen of the electronic apparatus, and the picture usually displays at lease one menu item of a menu item family.

The method for creating the picture in the present embodiment is based on the templates defined with the user interface descriptive tool. All the visible nodes (i.e. menu items) in the menu are processed by the picture generating method/tool. First, at least a template is defined (step S710). Each template includes at least a frame, and the data of the frame includes a position, a menu item code to be displayed, and a display mode. Wherein, the steps of defining the template may include: drawing at least one frame on the template for denoting the display positions of the menu item family, appointing the menu item from the family for each frame, and assigning a menu item code to denote the appointed menu item, and setting the display mode for each frame.

Next, the menu item family of each menu item is linked to one of the defined templates (step S720). Wherein, the size of the template is smaller than or equal to the size of the screen. Then, a picture buffer is set up for a menu item (step S730). Here a frame data of the template is read (step S740), wherein an icon corresponding to the menu item designated by the menu item code of the frame is read and processed according to the display mode of the frame, and then stored in the picture buffer according to the position of the frame. Wherein, the display mode of the frame may be one of highlight, brightening, and overlapping with existing picture, or the combination thereof, but is not limited thereto. Moreover, the method or steps disclosed above may also be implemented as the software or hardware means, tools, or devices for the user to accomplish these method or steps.

Next, whether there are unprocessed frames in the template is determined (step S750). If YES, back to step S740, the next frame is read and processed similarly, otherwise the content of the picture buffer is output as the picture data of the menu item (step S760).

After the picture data of the menu item is processed, it is determined whether there are unprocessed menu item in the menu item family (step S770). If YES, the procedure returns to step S730 to set up the picture data for the next menu item, otherwise, it means the picture data of all the menu items in the menu item family have been completed (step S780).

Moreover, in an embodiment, a computer readable recording media which can store menu data structure is used for setting up a user interface menu. The menu is a tree structure having a root node and a plurality of connected nodes, and at least one sub-node family can be derived from each node. Wherein, the menu data structure can record the data of each node including the action to be executed, the picture to be displayed, at least one key to receive, and at least one offset.

It should be noted that the foregoing keys are used for leading the nodes to the adjacent nodes, and the offset refers to the memory offset of the node and the adjacent node led by the key. Wherein, the foregoing adjacent nodes may include one of the parent node, the elder brother node next to it, the younger brother node next to it, the direct lineage eldest son node, or the concubine sub-node (or concubine eldest son node) of the node, or the combination thereof, and the user can use a super key to move the node to the concubine sub-node (or concubine eldest son node). In addition, the menu data structure may further include the property of each node, including one of visible, invisible, instant execution, execution on exit, and execution on right key, or the combination thereof, the scope thereof is not limited. When the properties include invisible, the picture data of the node is NULL.

To sum up, in the user interface and the related design of the present invention, the user interface descriptive method and the picture producing method greatly increase the efficiency of the user interface design. According to the menu data structure disclosed, the entire design of the menu including the visible and invisible nodes and their relationship, the definition of the keys, the display picture data, the actions to be executed, and other properties is all covered, so that customizing the user interface can be achieved without changing the program of the electronic apparatus when the user needs to re-design the menu, thus the purpose of separating the apparatus program from the user interface design can be achieved.

It will be apparent to those skilled in the art that various modifications and variations can be made to the method and the structure of the present invention without departing from the scope or spirit of the invention. In view of the foregoing, it is intended that the present invention cover modifications and variations of this invention provided they fall within the scope of the following claims and their equivalents.

What is claimed is:

1. A user interface method of an electronic device, processed by a user interface processing program installed in the electronic device, the user interface method comprising:
providing at least one key;
providing a menu, wherein the menu is a tree structure having a root node and a plurality of connected nodes, at least one sub-node family can be derived from each node, wherein for each node it is defined one of a property, at least one key to receive, a picture to display, and an action to execute, or the combination thereof; and
providing a display, suitable for displaying the picture of the node,
wherein the key is suitable for moving the node to an adjacent node.

2. The user interface method as claimed in claim 1, wherein the adjacent nodes comprise one of the parent node, the elder brother node, the younger brother node, the direct lineage eldest son node, and the concubine sub-node of the node, or the combination thereof.

3. The user interface method as claimed in claim 1, wherein the property of the node comprises one of visible, invisible, instant execution, execution on exit, and execution on right key, or the combination thereof.

4. The user interface method as claimed in claim 1, wherein only one of the sub-node families is direct lineage sub-node family, and the other sub-node families are all concubine sub-node families.

5. The user interface method as claimed in claim 4, wherein the keys comprise a super key, and the function of the super key is to move from the node to a concubine sub-node.

6. A descriptive tool for a user interface, suitable for defining a user interface of an electronic device, the user interface descriptive tool comprising:
a menu structure defining tool, suitable for defining a menu structure, which is a tree structure having a root node and a plurality of connected nodes, and defining the menu structure comprising defining at least one sub-node family derived from each node;
a node defining tool, suitable for defining one of a property, an action to execute, and at least one key to receive of each node, or the combination thereof;
a picture defining tool for defining a picture of each node; and
an output tool, suitable for outputting a menu data structure, comprising the foregoing data of each node.

7. The user interface descriptive tool as claimed in claim 6, wherein the property comprise one of visible, invisible, instant execution, execution on exit, and execution on right key, or the combination thereof.

8. The user interface descriptive tool as claimed in claim 7, wherein the picture defining tool further comprises:
an icon connecting means for the user to connect at least an icon for each visible node.

9. The user interface descriptive tool as claimed in claim 7, wherein the picture defining tool further comprises:
a template tool, suitable for defining at least one template, and connecting one of the templates for each visible node family, so as to define a picture of each visible node.

10. The user interface descriptive tool as claimed in claim 6, wherein the menu data structure comprises one of a property, an action to execute, a picture to display, at least one key to receive, and at least one offset of each node, or the combination thereof.

11. The user interface descriptive tool as claimed in claim 6, wherein the offset comprises the memory offset of the node and the adjacent node directed by the key.

12. The user interface descriptive tool as claimed in claim 6, wherein the picture of the node is NULL when the property of the node comprises invisible.

13. A user interface parsing method of an electronic device, wherein the electronic device comprises a picture display, at least one key, and an apparatus menu data structure; wherein the parsing method is initialized with a current node; the parsing method comprises:
a. reading the data of the current node from the apparatus menu data structure whose data comprises at least one offset data, at least one key to receive, a picture to display, and an action to execute; and
b. updating the current node according to a key and the offset data when the key is entered by the user and is received.

14. The user interface parsing method as claimed in claim 13, wherein the node data of step a. further comprises a property, which comprises one of visible, invisible, instant execution, execution on exit, and execution on right key, or the combination thereof.

15. The user interface parsing method as claimed in claim 14, wherein step a. further comprises:
determining whether the property of the node comprises instant execution;
executing the action of the node and displaying the picture of the node if instant execution is comprised; and
displaying the picture of the node directly if instant execution is not comprised.

16. The user interface parsing method as claimed in claim 14, wherein step b. further comprises the following steps before updating the current node:
determining whether the property of the node comprises execution on exit; and
allowing the electronic apparatus to execute the action of the node if execution on exit is comprised.

17. The user interface parsing method as claimed in claim 14, wherein step b. further comprises the following steps before updating the current node:
determining whether the property of the node comprises execution on right key; and
allowing the electronic apparatus to execute the action of the node if execution on right key is comprised and the key entered is a right key.

18. A method for producing the picture data of the menu item, suitable for displaying on a screen of an electronic device, wherein the picture displays at least one menu item of a menu item family, the method comprising:
a. providing a template defining tool for the user to define at least a template which comprises at least one frame, wherein the data of the frame comprises a position, a menu item code, and a display mode;
b. providing a connecting tool for the user to connect one of the templates to the menu item family which the menu item belongs to; and
c. constructing the picture data of the menu item according to the definition of the connected template.

19. The menu item picture data producing method as claimed in claim 18, wherein step a. further comprises:
a1. providing the user with drawing at least one frame on the template to represent the positions of the menu item family members shown on the picture; and
a2. providing the user with setting a menu item member for each frame, and assigning a menu item code to represent the menu item member displayed by the frame.

20. The menu item picture data producing method as claimed in claim 18, wherein step c. further comprises:
c1. setting up a picture buffer for each menu item; and
c2. reading the data of each frame of the template, reading an icon corresponding to the menu item code of the frame, processing the icon according to the display mode of the frame, and storing the processed icon into the picture buffer according to the frame position.
